(19) United States
(12) Patent Application Publication
(10) Pub. No.: US 2022/0393413 A1
(43) Pub. Date: Dec. 8, 2022

(54) Electrical Connector

(71) Applicant: Intelligent Growth Solutions Limited, St Andrews (GB)

(72) Inventor: Niall SKINNER, St Andrews (GB)

(21) Appl. No.: 17/775,385

(22) PCT Filed: Nov. 10, 2020
(86) PCT No.: PCT/GB2020/052849

§ 371 Date: May 9, 2022

(30) Foreign Application Priority Data
Nov. 11, 2019 (GB) 1916392.2
Jun. 23, 2020 (GB) 2009578.2

(51) Int. Cl. H01R 25/16; H01R 4/30

(52) U.S. Cl. CPC H01R 25/16; H01R 4/30

(57) ABSTRACT

Herein is provided a connector for providing an electrical connection between a conducting element and a connecting point, the connector comprising a first portion, a contacting element and second portion, the first portion being configured to be reversibly fastened to the second portion to thereby fasten a conducting element by the contacting element between the first portion and second portion.

### FIELD OF THE DISCLOSURE

The present disclosure is related to electrical connectors to connect conducting elements, more specifically to electrical connectors for connecting conducting elements in an electrical power distribution system.

### BACKGROUND

Industrial and Commercial spaces tend to be large, open spaces which can be relatively easily divided and configured to suit different applications and uses. The general design of such spaces allows for the simple fitting of room divisions, false ceilings, cabinetry, racking and shelving in a time and cost-efficient manner.

Such fittings are generally self-supporting and independent of building structure to allow for easy removal and reconfiguration as use of the building changes.

Often it is necessary in such open spaces to reconfigure the distribution of electrical power and/or communications as the requirements of the open space changes. For example, in an office environment, it may be necessary to re-arrange office spaces as the number of people working in that space changes, or when a new company moves into that space.

Electrical and communications infrastructure within such buildings is generally complex and time consuming to reconfigure. The two primary reasons for this are the specialist skills required in installation and removal due to the high voltages typically involved, requiring qualified electricians to carry out all work, increasing cost and reducing labour availability, and the number of separate systems involved in installation and complexity of fitting, including support system/cable tray for cabling, point to point cabling for all appliances, typically on separate circuits for each type of device, and separate mounting systems for each device, for example.

Accordingly, there is a need for a simplified connector for connecting conducting elements such as bus bars to an electrical power distribution system to provide electrical and communications infrastructure for an internal space that both provide a robust connection and a solid electrical connection between the bus bar and the system. In addition, there is a need for a connector that does not require complex installation, and does not require separate support.

At least some aspects of the described connectors are intended to at least partially address at least one of these problems.

### SUMMARY

A connector comprises a first portion, a contacting element and a second portion. The first portion may be configured to be reversibly fastened to the second portion. The first portion and second portion may form a cavity and the first portion may be configured to allow either the first end or the second end of a conducting element to be inserted into the cavity through the first portion. The second portion may be configured to attach the connector to a connecting point on a hub. Accordingly, the second portion may comprise a fastener on a side of the second portion opposed to the first portion when the first portion and second portion are fastened together. The contacting element may comprise a recess configured to receive an end of a conducting element. The contacting element may further comprise a plurality of gripping members that may be arranged around the recess.

According to a first aspect there is provided a connector for providing an electrical connection between a conducting element and a connecting point, the connector comprising a first portion, a contacting element and a second portion, the first portion being configured to be reversibly fastened to the second portion to thereby fasten a conducting element via the contacting element between the first portion and second portion.

The first portion and the second portion may form a cavity therebetween and the first portion may be configured to allow an end of a conducting element to be inserted into the cavity through the first portion. The second portion may be configured to attach the connector to a connecting point. The contacting element may comprise a recess configured to receive an end of a conducting element, and the contacting element may comprise a plurality of gripping members arranged around the recess.

The first portion may be annular. The first portion may define an aperture through the first portion. The first portion may comprise an annular wall that defines an aperture through the first portion.

The first portion may comprise an interior surface, and the interior surface may comprise a first threaded portion. The second portion may comprise an outer surface and the outer surface may comprise a second threaded portion. The first portion may be fastened to the second portion by screwing the first threaded portion to the second threaded portion.

In embodiments where the first portion comprises an annular wall, the first portion may comprise a channel that runs around a portion of the annular wall. The channel may be open on the interior side of the annular wall. The channel may be open on the exterior side of the annular wall. The channel may be closed on the exterior side of the annular wall. The first portion may comprise an opening that connects the channel to the end of the annular wall.

Accordingly, the channel may comprise a proximal end adjacent to the opening and a distal end furthest from the opening. The second portion may comprise a locking formation on the outer surface of the second portion. The first portion may be fastened to the second portion by inserting the locking formation of the second portion into the channel in the annular wall of the first portion via the opening. The first portion may then be rotated such that the locking formation of the second portion is rotated along the channel from the proximal end to the distal end, away from the opening, thereby fastening the first portion to the second portion.

The channel may extend around the diameter of the first portion at right angles to an axis of rotation of the first portion such that the channel remains at a separated from a peripheral edge of the annular wall. In other words, the proximal end of the channel may be at substantially the same distance from the peripheral edge of the annular wall as the distal end of the channel.

The channel may extend around the diameter of the first portion at an angle to the peripheral edge of the annular wall such that the distal end of the channel is further from the peripheral edge than the proximal end of the channel. Accordingly, rotation of the first portion relative to the second portion to move the locking formation of the second portion from the proximal end of the channel to the distal end of the channel may urge the second portion against the first portion, thereby fastening the first portion to the second portion.

The locking formation of the second portion may be integral with the outer surface of the second portion. Alternatively, the second portion may comprise a locking pin receiving formation configured to receive a locking pin to thereby form the locking formation. The locking pin may be secured within the locking pin receiving formation.

The first portion may comprise at least two channels running around at least two portions of the annular wall. The at least two portions of the annular wall may be arranged regularly around the annular wall. For example, in embodiments where the first portion comprises two channels, a first portion may be arranged on an opposed side of the annular wall to the second portion.

The second portion may comprise at least two locking formations arranged to be received into the openings of the at least two channels of the first portion. Accordingly, the second portion may comprise a number of locking formations that corresponds to the number of channels of the first portion.

The second portion may comprise a major element and a minor element. The major element may be of a first diameter and the minor element may be of a second diameter. The first diameter may be greater than the second diameter. The outer surface of the major element may be configured to contact the interior surface of the first portion when the first portion is fastened to the second portion. The outer surface of the minor element may comprise a gripping element. The gripping element may be configured to allow the second portion to be more readily fixed in place whilst the first portion is fastened to the second portion. The gripping element may comprise a flattened portion of the outer surface of the minor element. The gripping element may comprise a patterned portion of the outer surface of the minor element.

During use the second portion may be fastened to a connecting point of a hub. A first end of the conducting element may be inserted into the first portion and the first end of a conducting element to be attached to the hub may be inserted into the recess of the contacting element. The first portion may then be fastened to the second portion. As the first portion is fastened to the second portion the plurality of gripping members may be urged into contact with the conductive element to thereby form an electrical contact between the conducting element and the contacting element. The contacting element may be urged against the second portion to thereby form an electrical contact between the contacting element and the second portion.

The contacting element may comprise at least two gripping members. The contacting element may comprise at least three gripping members. The contacting element may comprise at least four gripping members. The contact element may comprise at least five gripping members. The contact element may comprise at least six gripping members.

Each gripping member may be deformable. Each gripping member may be resistive.

Accordingly, each gripping member may be deflected by the application of a force to the gripping member and once that force is removed, each gripping member may return to its original position.

Each gripping member may comprise an elongate element and a tapered portion. The elongate element may extend from a main body of the contacting element to the tapered portion. Each gripping member may be separated by a gap or space such that each gripping member within the plurality of gripping members may move relative to the one or more other gripping members within the plurality of gripping members. Accordingly, during use the tapered portion of each gripping member within the plurality of gripping members may be contacted by the tapered section of the first portion to thereby deflect the elongate elements such that the tapered portions are urged inward towards the surface of a conducting element to thereby grip the conducting element.

During use the contacting element may abut the second portion such that a surface of the contacting element contacts a surface of the second portion.

The first portion may comprise a hollow cylindrical portion. The hollow cylindrical portion may comprise the annular wall. The hollow cylindrical portion may comprise an internal cavity, a first opening and a second opening. The internal cavity, the first opening and the second opening may correspond to the aperture defined by the annular wall. During use an end of a conducting element may be inserted into the hollow cylindrical portion through the first opening. The internal surface of the hollow cylindrical portion may comprise a tapered section. The tapered section may reduce the diameter of the interior cavity of the hollow cylindrical portion. The tapered section may reduce the diameter of the interior cavity of the hollow cylindrical portion such that the diameter of the interior cavity is at a minimum diameter at the end of the tapered section adjacent to the end of the first portion. The tapered section may reduce the diameter of the interior cavity of the hollow cylindrical portion such that the diameter of the first opening is less than the diameter of the second opening. The tapered section may be located adjacent to the end of the first portion opposed to the end of the first portion that is fastened to the second portion. When the first portion is fastened to the second portion, the tapered section may urge the gripping members towards the conducting element retained within the cavity.

The connector may allow conducting elements to be readily fastened to a hub without requiring a wired connection and without requiring the ends of the conducting elements to be machined or otherwise prepared. For example, there is no requirement to provide a taper or other such modification to the or each end of the conducting elements.

Furthermore, this simple method of connecting conducting elements to an electrical distribution system may allow one or more conducting elements to be readily added to or removed from the system to allow the system to be reconfigured as required. In addition, the system can be assembled from multiple points on the system at the same time. For example, conducting elements may be connected to different hubs of the system at the same time, or a first end of a conducting element may be connected to a first hub at the same time as a second end of the conducting element is connected to a second hub. This contrasts with conventional cable and conduit systems where installations must be built out from a single fixed point

In some embodiments, the conducting element may be an elongate conducting element. The elongate conducting element may be a tubular conducting element. The elongate conducting element may be a cylindrical conducting element. The elongate conducting element may be a solid elongate conducting element.

Preferably, the conducting element comprises an electrically conductive material. The conducting element may comprise a metal, such as aluminium, iron, copper, steel or alloys thereof. Preferably, the metal is aluminium.

The conducting element may be a bus bar. The bus bars used with the connector of the present aspect includes; hollow bus bars; cylindrical bus bars; tubular or substantially tubular bus bars; hollow metal bus bars; tubular or substantially tubular metal bus bars; aluminium tubular or substantially tubular bus bars; aluminium hollow bus bars; copper tubular or substantially tubular bus bars; copper hollow bus bars; metal-coated hollow bus bars and combinations thereof.

The connector as described in at least some embodiments may be used to connect conducting elements transmitting low voltage power, preferably extra low voltage power. For example, the conducting elements may transmit single-phase or three-phase AC power that may be extra low voltage power of less than or equal to 50V AC RMS. Accordingly, the connector may be used to attach or remove a conducting element to a power distribution system without needing a qualified electrician as very low voltage and no wired connection is required to be made.

The connector of the present aspect may be used to connect conducting elements transmitting high voltage power and may allow conducting elements to be added or removed from a power distribution system. The power distribution system or at least a portion of the power distribution system may be disconnected from the high voltage power before a conducting element is added or removed from the system.

In a second aspect there is provided a connector comprising a central portion, a first outer portion, a second outer portion, a first contacting element and a second contacting element.

The connector may be configured to connect a first conducting element to a second conducting element. The first conducting element may be an elongate conducting element. The second conducting element may be an elongate conducting element. The first conducting element may be a cylindrical or tubular conducting element. The second conducting element may be a cylindrical or tubular conducting element.

The central portion may be configured to be secured to the first outer portion. The central portion may be configured to be secured to the second outer portion. The central portion may comprise a central body. The first outer portion and the central portion may form a first cavity. The second outer portion and the central portion may form a second cavity. The first contacting element may be adapted to be received within the first cavity. The second contacting element may be adapted to be received within the second cavity.

During use, a first conducting element may be received within the first contacting element and the first outer portion may be located over the first conducting element and the first contacting element. As the first outer portion is secured to the central portion the first contacting element may be urged into contact with the first conducting element.

During use, a second conducting element may be received within the second contacting element and the second outer portion may be located over the second conducting element and the second contacting element. As the second outer portion is secured to the central portion the second contacting element may be urged into contact with the second conducting element.

The first contacting element may comprise a plurality of gripping members. The plurality of gripping members may be urged into contact with a first conductive element as the first outer portion is secured to central portion to thereby from an electrical contact between the first conducting element and the contacting element. The first contacting element may be urged against the central portion to thereby form an electrical contact between the first contacting element and the central portion.

The second contacting element may comprise a plurality of gripping members. The plurality of gripping members may be urged into contact with a second conductive element as the second outer portion is secured to central portion to thereby form an electrical contact between the second conducting element and the second contacting element. The second contacting element may be urged against the central portion to thereby form an electrical contact between the second contacting element and the central portion.

The first and/or second contacting element may comprise at least two gripping members. The first and/or second contacting element may comprise at least three gripping members. The first and/or second contacting element may comprise at least four gripping members.

Each gripping member may be deformable. Each gripping member may be resistive.

Accordingly, each gripping member may be deflected by the application of a force to the gripping member and once that force is removed, each gripping member may return to its original position.

Each gripping member may comprise an elongate element and a tapered portion. The elongate element may extend from a main body of the contacting element to the tapered portion. Each gripping member may be separated by a gap or space such that each gripping member within the plurality of gripping members may move relative to the one or more other gripping members within the plurality of gripping members. Accordingly, during use the tapered portion of each gripping member within the plurality of gripping members may be contacted by the tapered section of the first portion to thereby deflect the elongate elements such that the tapered portions are urged inward towards the surface of a conducting element to thereby grip the conducting element.

During use the first contacting element may abut the central portion such that a surface of the first contacting element contacts a surface of the central portion. During use the second contacting element may abut the central portion such that a surface of the second contacting element contacts a surface of the central portion.

In some embodiments, the first conducting element and/or the second conducting element may be elongate conducting elements. The elongate conducting elements may be tubular conducting elements. The elongate conducting elements may be cylindrical conducting elements. The elongate conducting elements may be solid elongate conducting elements.

Preferably, the first and second conducting elements comprise an electrically conductive material. The first and/or second conducting element may comprise a metal, such as aluminium, iron, copper, steel or alloys thereof. Preferably, the metal is aluminium.

The first and/or second conducting element may be a bus bar. The bus bars used with the connector of the present aspect includes; hollow bus bars; cylindrical bus bars; tubular or substantially tubular bus bars; hollow metal bus bars; tubular or substantially tubular metal bus bars; aluminium tubular or substantially tubular bus bars; aluminium hollow bus bars; copper tubular or substantially tubular bus bars; copper hollow bus bars; metal-coated hollow bus bars and combinations thereof.

Preferred and optional features of the first aspect are preferred and optional features of the second aspect.

### BRIEF DESCRIPTION OF THE FIGURES

Embodiments of the present invention will now be described, by way of non-limiting example, with reference to the accompanying drawings.

FIG. 1: A) A side cross-section of a connector according to an embodiment connecting a bus bar to a hub, B) An exploded side cross-section of a first portion, a contact element and a second portion of a connector, a bus bar and a hub comprising connecting points;

FIG. 2: A schematic cross section of a connector according to an embodiment;

FIG. 3: A perspective view of a connector according to an embodiment;

FIG. 4: A schematic cross section of a contact element of a connector according to an embodiment;

FIG. 5: A perspective view of a contact element of a connector according to an embodiment;

FIG. 6: A schematic cross section of a first portion of a connector according to an embodiment;

FIG. 7: A perspective view of a first portion of a connector according to an embodiment;

FIG. 8: A side view of a second portion of a connector according to an embodiment;

FIG. 9: A perspective view of a second portion of a connector according to an embodiment;

FIG. 10: A) A schematic cross section of a connector according to an embodiment, B) a perspective view of a connector according to an embodiment;

FIG. 11: A schematic cross section of a connector according to an embodiment connecting a first bus bar to a second bus bar;

FIG. 12: a schematic cross section of a first side of the connector of FIG. 11;

FIG. 13: a schematic cross section of a second side of the connector of FIG. 11;

FIG. 14: a schematic cross section of a connector according to an embodiment;

FIG. 15: a perspective view of a connector according to an embodiment;

FIG. 16: a schematic cross section of a first portion according to an embodiment;

FIG. 17: a perspective view of a first portion according to an embodiment;

FIG. 18: a schematic cross section of a second portion according to an embodiment; and

FIG. 19: a perspective view of a second portion according to an embodiment.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

### Example 1

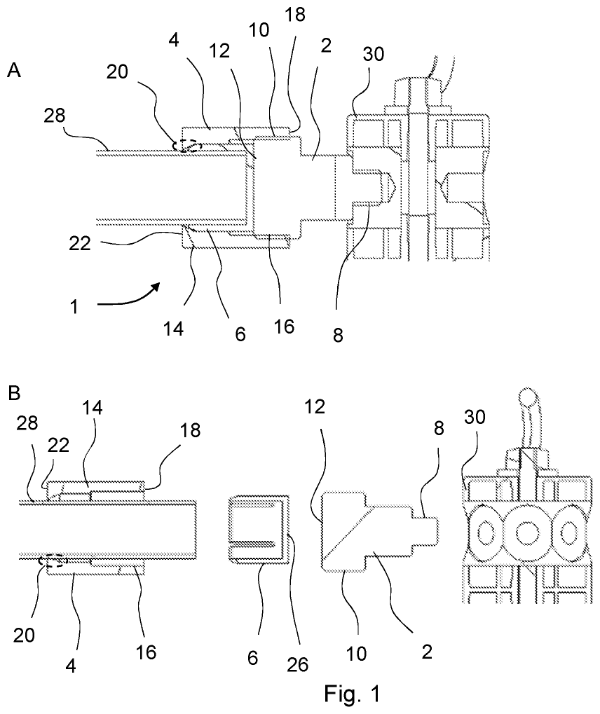

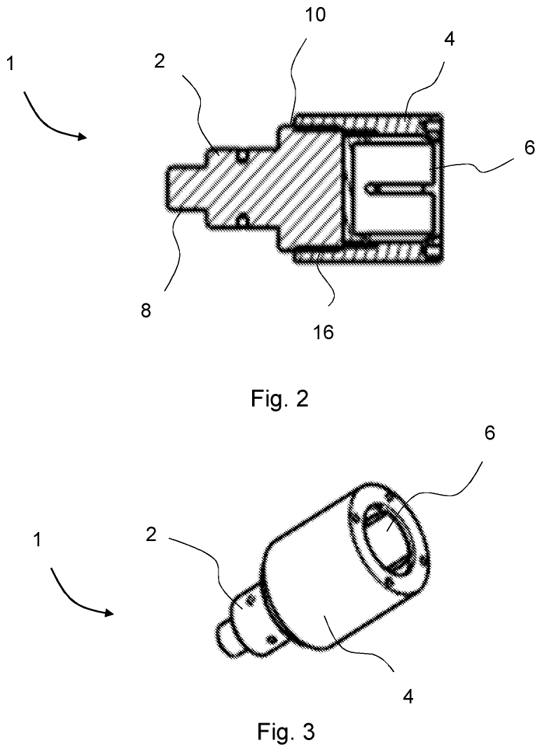

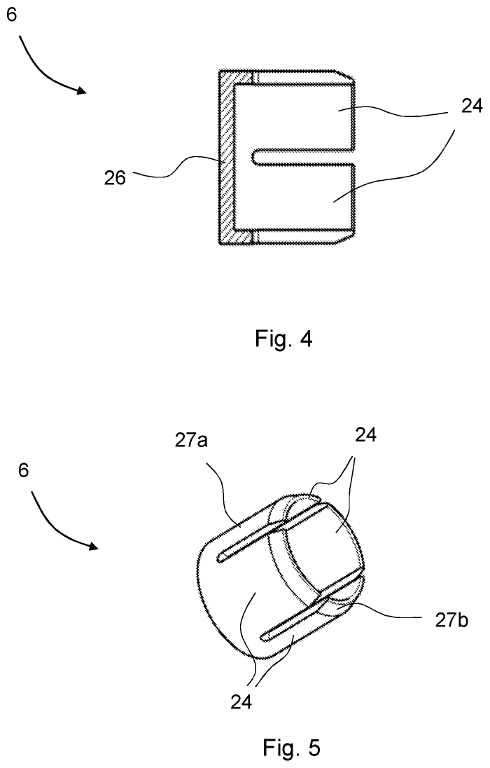

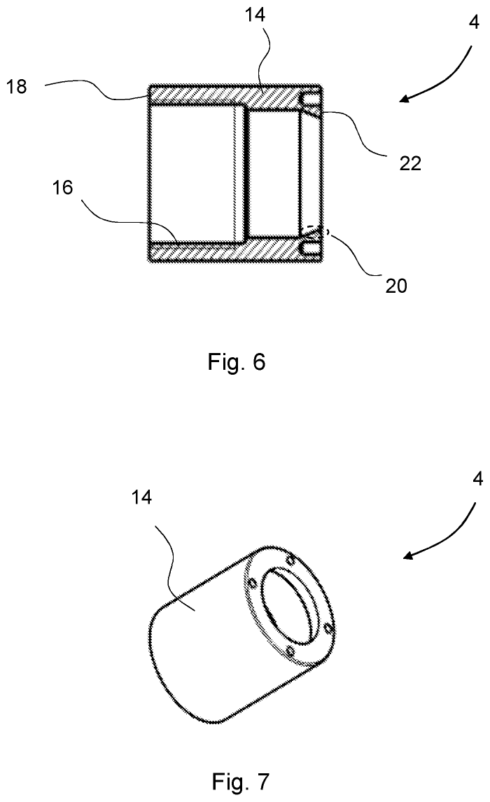

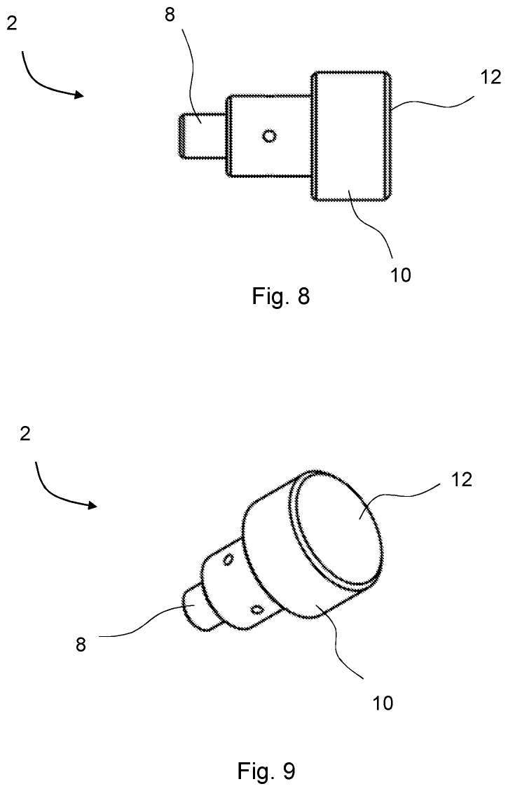

With reference to FIGS. 1 to 9, a connector 1 comprises a stud 2 (acting as a second portion), a nut 4 (acting as a first portion) and a collet 6 (acting as a contact element). The stub 2 comprises a hub threaded screw 8, a nut threaded screw 10 and a collet contacting surface 12. The nut 4 comprises a hollow cylindrical body 14. The interior of the hollow cylindrical body 14 comprises an internal thread 16 configured to screw onto the nut threaded screw 10 of the stub 2 on one end 18 of the hollow cylindrical body 14, and a tapered portion 20 (acting as tapered element) on the opposite end 22 of the hollow cylindrical body 14. The collet 6 comprises four deformable elements 24 (acting as gripping elements) arranged around a cavity, and a base 26 (acting as a second portion contacting surface). Each deformable element 24 comprises an elongate element 27a, and a tapered member 27b.

During use, the nut 4 is placed over the end of a bus bar 28 that is to be attached to a hub 30 and the collet 6 is placed over the end of a bus bar 28 behind the nut 4. The internal thread 16 of the nut 4 is then screwed onto the nut threaded screw 10 of the stub 2. As the nut 4 is secured to the stub 2 the base 26 abuts the collet contacting surface 12 and the four deformable elements 24 grip the end of the bus bar 28 by the tapered portion 20 contacting the tapered member 27b of the deformable elements 24 and urging them inward (i.e. toward the surface of the bus bar 28) to bend the elongate elements 27a towards the bus bar 28.

As a result, the four deformable elements 24 make an effective electrical contact onto the surface of the bus bar 28 and the base 26 of the collet 6 makes an effective electrical contact onto the collet contacting surface 12 of the stub 2. Finally, the stub 2 makes an effective electrical contact with the hub 30 via the hub threaded screw 8. Accordingly, the connector 1 provides an effective electrical contact between a bus bar of a bus bar group to a hub via a simple action of screwing the nut 4 onto the stub 2, thereby not requiring any wiring or any qualified electricians to attach bus bars to form the system.

### Example 2

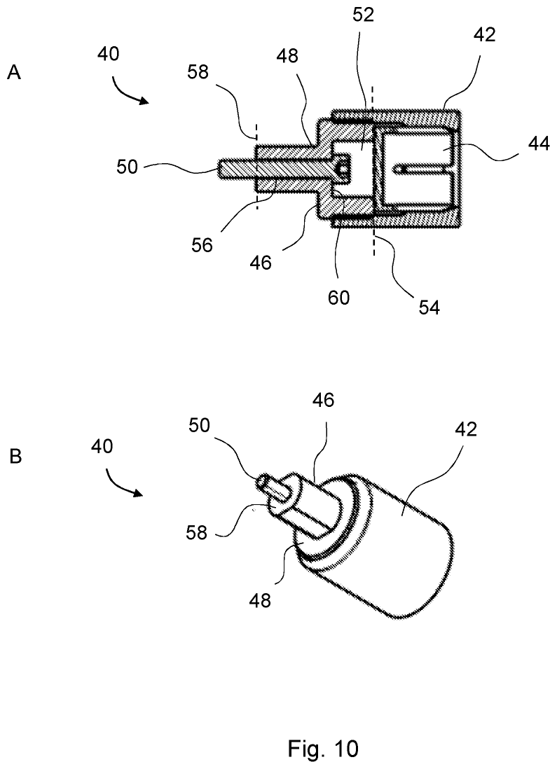

An alternative embodiment of a connector is shown in FIG. 10, wherein the connector 40 comprises a nut 42 and a collet 44 as per Example 1, with a stud 46 that comprises a main body 48, and a central screw 50. The main body 48 comprises a central recess 52 within a collet contacting surface 54, and a central bore 56 extends from the central recess 52 to a side 58 opposed to the side 60 of the main body 48 that fastens to the nut 42, and through which the central screw 50 extends.

During use, the central screw 50 may be screwed into a connecting point of a hub (not shown) through the main body 48 of the stud 46 before the nut 42 is fastened to the main body 48.

### Example 3

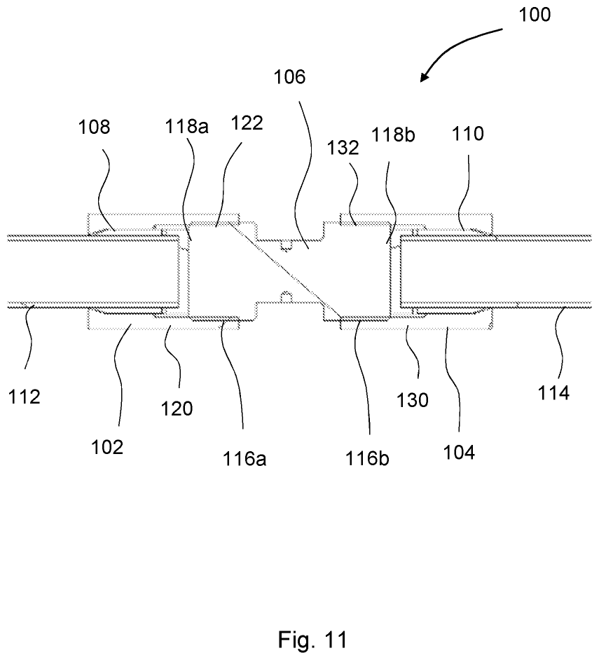

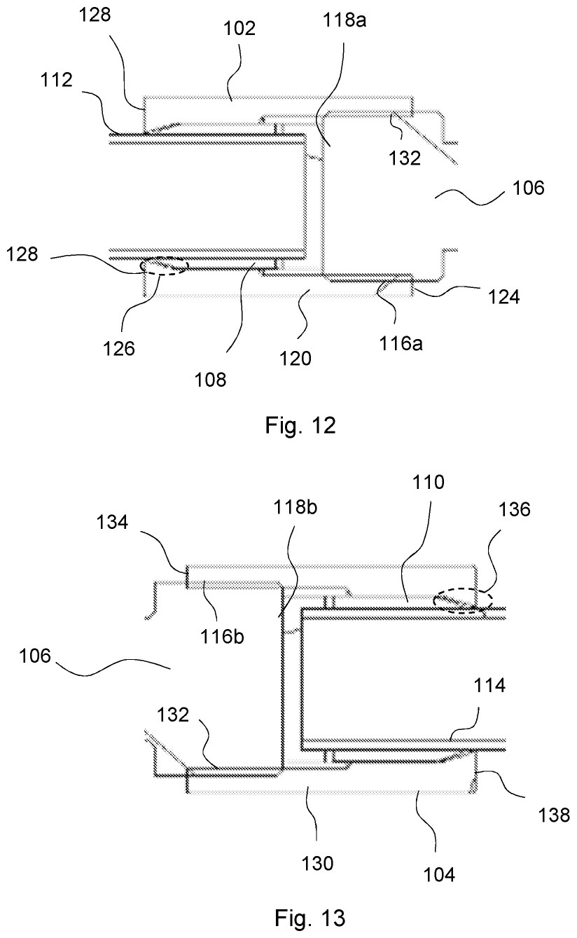

With reference to FIGS. 11-13, a connector 100 comprises a first nut 102 (acting as a first outer portion), a second nut 104 (acting as a second outer portion), a coupler 106 (acting as a central portion), a first collet 108 (acting as a first contacting element), and a second collet 110 (acting as a second contacting element). The connector 100 is configured to connect a first bus bar 112 to a second bus bar 114.

The coupler 106 comprises a first nut threaded screw 116a, a second nut threaded screw 116b, a first collet contacting surface 118a, and a second collet contacting surface 118b.

The first nut 102 comprises a hollow cylindrical body 120. The interior of the hollow cylindrical body 120 comprises an internal thread 122 configured to screw onto the first nut threaded screw 116a of the coupler 106 on one end 124 of the hollow cylindrical body 120, and a tapered portion 126 (acting as a tapered section) on the opposite end 128 of the hollow cylindrical body 120. The second nut 104 comprises a hollow cylindrical body 130. The interior of the hollow cylindrical body 130 comprises an internal thread 132 configured to screw onto the second nut threaded screw 116b of the coupler 106 on one end 134 of the hollow cylindrical body 130, and a tapered portion 136 (acting as a tapered section) on the opposite end 138 of the hollow cylindrical body 130.

The first collet 108 and the second collet 110 correspond to the collet of the of Example 1.

During use a first end of the first bus bar 112 is inserted into the first nut 102. The first collet 108 is placed over the first end of the first bus bar 112 and the internal thread 122 is screwed onto the first nut threaded screw 116a. As the first nut 102 is screwed onto the coupler 106, the four deformable elements are urged into contact with the surface of the first bus bar 112. Similarly, a first end of the second bus bar 114 is inserted into the second nut 104. The second collet 110 is placed over the first end of the second bus bar 114 and the internal thread 132 is screwed onto the second nut threaded screw 116b. As the second nut 104 is screwed onto the coupler 106, the four deformable elements are urged into contact with the surface of the second bus bar 114.

Accordingly, a secure electrical contact is made between the first bus bar 112 and the second bus bar 114 via the first collet 108, the coupler 106 and the second collet 110.

### Example 4

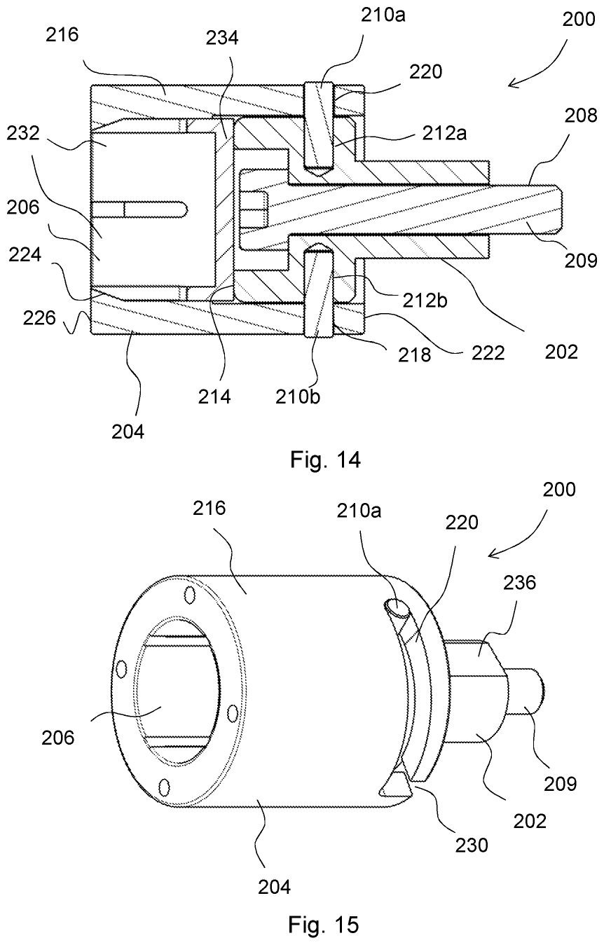

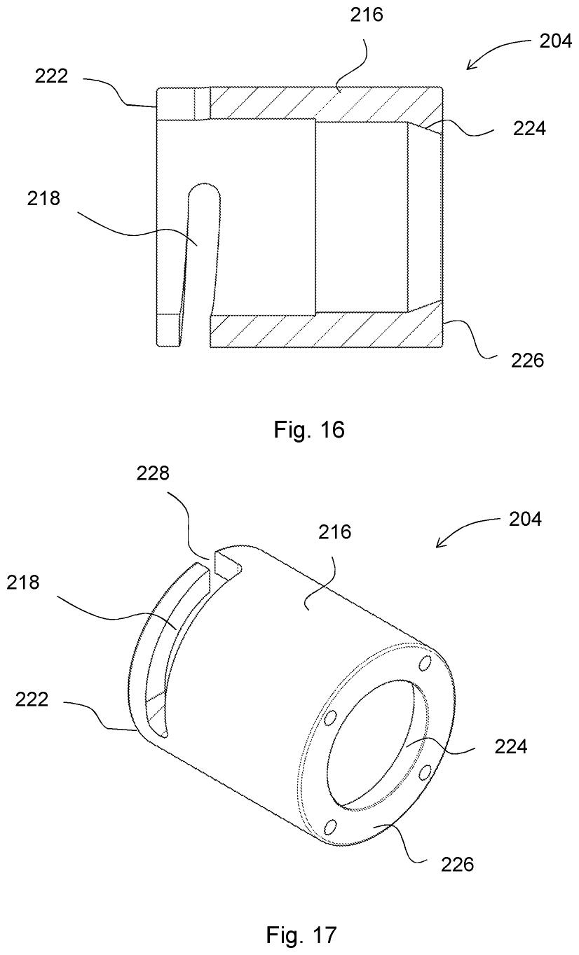

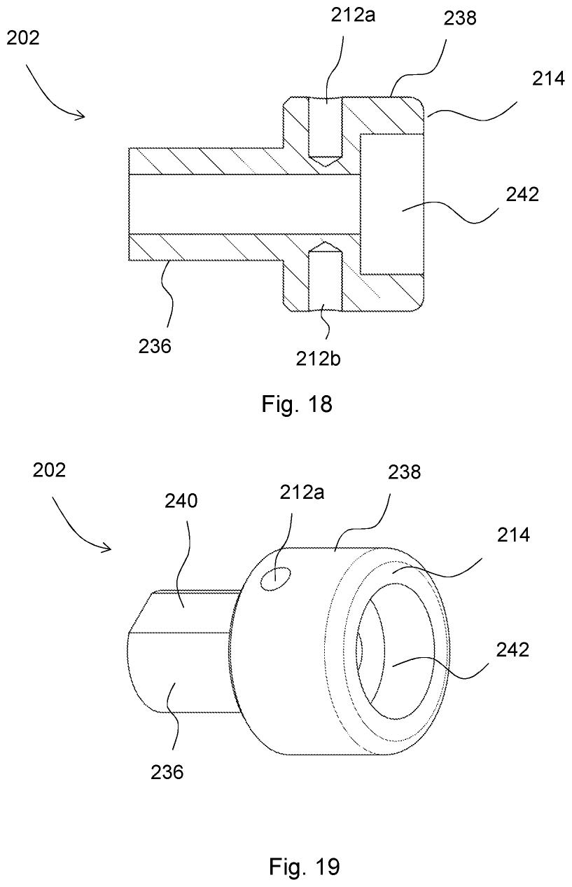

With reference to FIGS. 14 to 19, a connector 200 comprises a stud 202 (acting as a second portion), a nut 204 (acting as a first portion) and a collet 206 (acting as a contact element). The stud 202 comprises a hub threaded screw 208 provided on screw 209 that extends through the stud 202, a first locking pin 210a and a second locking pin 210b, and a collet contacting surface 214. The first locking pin 210a is received within a first pin aperture 212a and the second locking pin 210b is received within a second pin aperture 212b.

The nut 204 comprises a hollow cylindrical body 216. The hollow cylindrical body 216 (acting as an annular wall) comprises a first pin channel 218 and a second pin channel 220 adjacent to a first end 222, and a tapered portion 224 (acting as tapered element) on the opposite end 226 of the hollow cylindrical body 216. The first pin channel 218 comprises an opening 228 and the second pin channel 220 comprises an opening 230. The collet 206 comprises four deformable elements 232 (acting as gripping elements) arranged around a cavity, and a base 234 (acting as a second portion contacting surface).

The stud 202 comprises a gripping portion 236 (acting as a minor portion) and a connecting portion 238 (acting as a major portion). The gripping portion 236 is cylindrical with two flattened sides 240 that allow the user to firmly grip the stud 202. The connecting portion 238 is cylindrical and comprises the first locking pin 210a received within the first pin aperture 212a and the second locking pin 210b received within the second pin aperture 212b. The stud 202 further comprises a recessed portion 242 that is configured to receive the head of a screw 209 or bolt.

During use, the nut 204 is placed over the end of a bus bar that is to be attached to a hub and the collet 206 is placed over the end of a bus bar behind the nut 204. The first locking pin 210a is received into the opening 228 of the first pin channel 218 and the second locking pin 210b is received into the opening 230 of the second pin channel 220. The nut 204 is then rotated such that the first locking pin 210a travels along the first pin channel 228 and the second locking pin 210b travels along the second pin channel 220. The first pin channel 218 and the second pin channel 220 are angled such that as the first locking pin 210a moves along the first pin channel 218 and as the second locking pin 210b moves along the second pin channel 220 the stud 202 is urged into the nut 204, thereby fastening the stud 202 to the nut 204.

As the nut 204 is secured to the stud 202 the base 234 abuts the collet contacting surface 214 and the four deformable elements 232 grip the end of the bus bar by the tapered portion 224 contacting the tapered member of the deformable elements 232 and urging them inward (i.e. toward the surface of the bus bar) to bend the elongate elements of the collet 206 towards the bus bar.

As a result, the four deformable elements 232 make an effective electrical contact onto the surface of the bus bar and the base of the collet 206 makes an effective electrical contact onto the collet contacting surface 214 of the stud 202. Finally, the stud 202 makes an effective electrical contact with the hub via the hub threaded screw 208. Accordingly, the connector 200 provides an effective electrical contact between a bus bar of a bus bar group to a hub via a simple action of screwing the nut 204 onto the stud 202, thereby not requiring any wiring or any qualified electricians to attach bus bars to form the system.

While there has been hereinbefore described embodiments of the present invention, it will be readily apparent that many and various changes and modifications in form, design, structure and arrangement of parts may be made for other embodiments without departing from the invention and it will be understood that all such changes and modifications are contemplated as embodiments as a part of the present invention as defined in the appended claims.

1. A connector for providing an electrical connection between a conducting element and a connecting point, the connector comprising a first portion, a contacting element and a second portion, the first portion being configured to be reversibly fastened to the second portion to thereby fasten a conducting element by the contacting element between the first portion and second portion.

2. A connector according to claim 1, wherein the first portion and the second portion form a cavity therebetween and the first portion being configured to allow an end of an elongate conducting element to be inserted into the cavity through the first portion, the second portion being configured to attach the connector to a connecting point, wherein the contacting element comprises a recess configured to receive an end of a conducting element, and the contacting element comprises a plurality of gripping members arranged around the recess.

3. A connector according to claim 1, wherein during use the second portion may be fastened to a connecting point of a hub.

4. A connector according to claim 1, wherein during use the plurality of gripping members are urged into contact with the conductive element as the first portion is fastened to the second portion to thereby from an electrical contact between the conducting element and the contacting element.

5. A connector according to claim 1, wherein the contacting element is urged against the second portion to thereby form an electrical contact between the contacting element and the second portion.

6. A connector according to claim 1, wherein the contacting element comprises at least four gripping members.

7. A connector according to claim 1, wherein during use the contacting element abuts the second portion such that a surface of the contacting element contacts a surface of the second portion.

8. A connector according to claim 1, the first portion comprises a hollow cylindrical portion.

9. A connector according to claim 8, wherein the hollow cylindrical portion comprises an internal surface and the internal surface of the hollow cylindrical portion comprises a tapered section that reduces the internal diameter of the hollow cylindrical portion.

10. A connector according to claim 9, wherein the tapered section is located adjacent to an end of the first portion opposed to an end of the first portion that is fastened to the second portion and the internal diameter of the hollow cylindrical portion is at a minimum at or adjacent to the end of the first portion opposed to the end of the first portion that is fastened to the second portion.

11. A connector according to claim 1, wherein the connector provides an electrical connection between an elongate tubular conducting element and a connecting point.

12. A connector according to claim 11, wherein the conducting element comprises aluminium.

13. A connector according to claim 11, wherein the conducting element is a bus bar.

14. A connector according to claim 1, wherein the connector provides an electrical connection to a conducting element that is transmitting extra low voltage power.

15. A connector for connecting a first conducting element and a second conducting element, the connector comprising a central portion, a first outer portion, a second outer portion, a first contacting element and a second contacting element, the central portion being configured to be secured to the first outer portion and to be secured to the second outer portion, and to thereby secure the first conducting element between the first contacting element, the central portion and the first outer portion, and to thereby secure the second conducting element between the second contacting element, the central portion and the second outer portion.

16. A connector according to claim 15, wherein the first outer portion and the central portion form a first cavity, the second outer portion and the central portion form a second cavity, the first contacting element is adapted to be received within the first cavity and the second contacting element is adapted to be received within the second cavity.

17. A connector according to claim 15, wherein during use, a first conducting element is received within the first contacting element and the first outer portion is located over the first conducting element and the first contacting element such that when the first outer portion is secured to the central portion the first contacting element is urged into contact with the first conducting element.

18. A connector according to any of claim 15, wherein during use, a second conducting element is received within the second contacting element and the second outer portion is located over the second conducting element and the second contacting element such that when the second outer portion is secured to the central portion the second contacting element is urged into contact with the second conducting element.
